(19) United States
(12) Patent Application Publication
(10) Pub. No.: US 2026/0004674 A1
(43) Pub. Date: Jan. 1, 2026

(54) SYSTEM AND METHOD FOR TRAINING RESERVOIR ENGINEERS BASED ON DIGITAL TWIN TECHNOLOGY

(71) Applicant: Southwest Petroleum University, Chengdu (CN)

(72) Inventors: SUYANG ZHU, Chengdu (CN); XINYU ZENG, Chengdu (CN); HONGJUN ZHU, Chengdu (CN); JINGJING GUO, Chengdu (CN); YONG TANG, Chengdu (CN); XIAOQIANG BIAN, Chengdu (CN); PING YUE, Chengdu (CN); JINZE SONG, Chengdu (CN)

(21) Appl. No.: 19/235,142

(22) Filed: Jun. 11, 2025

(30) Foreign Application Priority Data
Jun. 26, 2024 (CN) 202410832295.2

(51) Int. Cl. G09B 9/00; G06F 30/28

(52) U.S. Cl. CPC G09B 9/00; G06F 30/28

(57) ABSTRACT

Disclosed are a system and a method for training reservoir engineers based on digital twin technology. The training system includes a data operation workstation, a data distribution server and an intelligent terminal; trainees view initial data of reservoir geology by the intelligent terminal to form a preliminary understanding of the reservoir, and then issue reservoir development instructions; according to the development instructions, the reservoir numerical simulation operation module sends feedback data to the intelligent terminal after simulation calculation for the trainees to view, and the trainees analyze and determine reservoir feedback information, thereby forming a new understanding of the reservoir. After having updated understanding of the reservoir, the trainees issue a reservoir development instruction again by the intelligent terminal until the oil and gas field development is completed. After completion, the data operation workstation outputs recovery factor and profit amount of this development simulated by the trainees as simulation results.

### CROSS-REFERENCE TO RELATED APPLICATIONS

This application claims priority to Chinese Patent Application No. 202410832295.2, filed on Jun. 26, 2024, which is hereby incorporated by reference in its entirety.

### TECHNICAL FIELD

The present invention relates to the technical field of oil and gas field development, and in particular, to a system and a method for training reservoir engineers based on digital twin technology.

### BACKGROUND

In the field of oil and gas field development engineering, the key professional competency of a reservoir engineer lies in utilizing dynamic analysis methods of reservoir engineering to inversely obtain physical properties of reservoir formations, thereby achieving a comprehensive understanding of reservoirs. This process integrates knowledge from dozens of research fields, including reservoir geology, sedimentary rocks and facies, petrophysics, fluid flow mechanics, and well test analysis, which is recognized as the process of acquiring reservoir engineering experience in the industry.

Currently, reservoir engineers primarily acquire professional experience through lectures or on-site training. However, these conventional methods provide limited practical experience and in-depth understanding. This is because reservoir engineering is a highly systematic and application-driven discipline. True mastery requires continuous practical implementation of learned concepts post-training, combined with real-world feedback. Only through this iterative process can reservoir engineers fully internalize theoretical knowledge, apply these theories effectively, and develop an operational understanding of reservoirs. In the actual reservoir development, reservoir engineers issue operational instructions based on their understanding of the reservoir. The reservoir then responds to these instructions through production performance feedbacks. The ability to dynamically interpret and learn from these feedbacks is critical to the professional growth of reservoir engineers. In addition, organizing such lectures or training programs not only consumes significant manpower and resources but is also limited by time and location, making it inefficient for enhancing the professional competency of reservoir engineers.

Currently, there is no method that may realistically simulate actual reservoir development conditions for training reservoir engineers. Moreover, the acquisition of reservoir engineering experience requires substantial time and economic costs. This stems from the fact that such experience is predominantly gained through practical engagement in oil and gas field development projects. Inevitably, this process involves imperfect reservoir characterization, and such inaccuracies frequently result in financial losses. Thus, the acquisition of reservoir engineering experience is still a time-consuming and labor-intensive yet critically essential process.

### SUMMARY

To address the time-consuming, labor-intensive, and low efficiency of the current training method for professional competency of reservoir engineers, the present invention provides a system and a method for training reservoir engineers based on digital twin technology. Through this training system, reservoir engineers may efficiently acquire accurate reservoir development experience in a short period, thereby progressively developing reservoir engineering expertise.

The training system and method provided by the present invention integrate existing reservoir models and development experience with digital twin technology, and enable simultaneous large-scale trainee participation with iterative inversion and simulation of development processes. Thus, the trainees may rapidly, efficiently, and cost-effectively acquire reservoir engineering experience for a type of reservoirs. The trainees refer to reservoir engineers requiring professional training.

The system for training reservoir engineers based on digital twin technology provided in the present invention includes a data operation workstation, a data distribution server, and an intelligent terminal.

The data operation workstation receives an operation instruction of the data distribution server, performs simulation calculation on data input through the intelligent terminal according to a reservoir development instruction, and issues a calculation result to the intelligent terminal through the data distribution server. The data operation workstation includes a reservoir numerical model storage module and a reservoir numerical simulation operation module.

The reservoir numerical model storage module is configured to store currently developed reservoir data information and establish a reservoir numerical model based on the data information. Specifically, the reservoir numerical model storage module stores data information of a reservoir of the same type that has been developed for more than ten years and has a full understanding of the reservoir, which is selected by industry experts based on the type of a to-be-developed reservoir, and grid encryption is performed to form the reservoir numerical model after a geological model and an in-situ stress model are fused based on the data information. The geological model includes data on stratigraphic horizons, depth, porosity, permeability, saturation, water zones, sensitivity, relative permeability, and capillary pressure distribution. The in-situ stress model includes data on fracture zones, Young's modulus, Poisson's ratio, and Lame constants distribution.

The reservoir numerical simulation operation module is configured to perform simulation calculation on a development instruction input by the intelligent terminal and send a calculation result to the intelligent terminal through the data distribution server.

The data distribution server receives an operation instruction of the intelligent terminal and transmits the operation instruction to the data operation workstation; and distributes an operation result of the data operation workstation to the intelligent terminal.

A plurality of the intelligent terminals are provided, each of which has three main functions: viewing the reservoir numerical model stored in the data operation workstation by the trainees, issuing the reservoir development instruction, and viewing reservoir dynamic feedback data of a numerical simulation result in the data operation workstation.

On the intelligent terminal, trainees can access stored top surface horizon data of a reservoir, including geological information, fluid properties, and production history for no more than 10 wells within a one-year period, and perform geological modeling, fluid property analysis, and reservoir engineering dynamic analysis to develop a preliminary understanding of the reservoir. The geological information includes a numerical logging curve given by the numerical model, a porosity-permeability-saturation test result at a production well, as well as a relative permeability curve and a capillary pressure curve measured at a production well. The fluid properties include the phase behavior, density, viscosity, and volume factor of the fluid at the location of the production well. The production history includes production rates, pressure data, and numerical well test analysis results.

The reservoir development instruction includes one of the following:
(1) Drilling instruction: drilling a well at target point coordinates;
(2) Coring instruction: taking a core sample at a depth in a well;
(3) Fracturing instruction: performing fracturing on a well, with fracturing parameters defined by trainees;
(4) Production instruction: performing production of a well within a specified production rate or a bottomhole pressure limit;
(5) Test instruction: testing a static pressure at a bottom of a production well, logging data, and performing a well testing instruction; and
(6) Injection instruction: Injecting water, gas, polymer or surfactant into an injection well.

According to the reservoir development instruction issued by the intelligent terminal, the reservoir numerical simulation operation module sends the following feedback data to the intelligent terminal after simulation calculation:
(1) Feedback on the drilling instruction: forming a responsive well at target point coordinates;
(2) Feedback on the coring instruction: feeding back porosity, saturation and permeability parameters, a relative permeability curve and a capillary pressure curve, as well as fluid properties of a grid at a depth of a well;
(3) Feedback on the fracturing instruction: feeding back a shape of a pressure construction curve;
(4) Feedback on the production instruction: feeding back daily production and bottomhole flowing pressure over time;
(5) Feedback on the test instruction: feeding back the static pressure of a test well, a logging curve in the numerical model, and a relationship between the bottomhole flowing pressure and production obtained from the well test; and
(6) Feedback on the injection instruction: a relationship of bottomhole flowing pressure changes in the injection well, and daily production and bottomhole flowing pressure of adjacent wells near the injection well changing with time.

The operation process of the entire training system is as follows: trainees view initial data of reservoir geology by the intelligent terminal to form a preliminary understanding of the reservoir, and then issue reservoir development instructions such as drilling, logging, and test production; after receiving the development instructions, the data distribution server distributes the development instructions to an operation core of the reservoir numerical simulation operation module in the data operation workstation; the operation core performs numerical simulation calculations, and the calculation result data is then returned to the intelligent terminal through the data distribution server for viewing by the trainees; and the trainees analyze and determine reservoir feedback information, thereby forming a new understanding of the reservoir.

After having updated understanding of the reservoirs, the trainees issue a reservoir development instruction again by the intelligent terminal until the oil and gas field development is completed. After completion, the data operation workstation outputs recovery factor and profit amount of this development simulated by the trainees as simulation results.

The present invention further provides a training method by adopting the system for training reservoir engineers based on digital twin technology, which includes the following steps:

S1. A type of reservoir numerical model is formed by selecting data information of a reservoir of the same type that has been developed for more than ten years and has a full understanding of the reservoir by industry experts based on the type of a to-be-developed reservoir, and stored in a data operation workstation.

Specifically, industry experts select an oil reservoir or a gas reservoir which has been developed for a long time (more than ten years) and has a full understanding of the reservoir based on a type of reservoir (which type of reservoir is used when the development experience of this type of reservoir is obtained); and grid encryption is performed to form a high-precision numerical model after a geological model (including data on stratigraphic horizons, depth, porosity, permeability, saturation, water zones, sensitivity, relative permeability, and capillary pressure distribution) and an in-situ stress model (distribution of fracture zones, Young's modulus, Poisson's ratio, and Lame constants) are fused, and this model is stored in a data operation workstation.

S2. The trainees view geological information of the numerical model of the reservoir by the intelligent terminal to form a preliminary understanding of the reservoir.

The trainees only view top surface horizon data of the reservoir (seismic interpretation results), including geological information, fluid properties and production history of no more than 10 wells within 1 year. The geological information includes a numerical logging curve given by the numerical model, a porosity-permeability-saturation test result at a production well, as well as a relative permeability curve and a capillary pressure curve measured at a production well. The fluid properties include the phase behavior, density, viscosity, and volume factor of the fluid at the location of the production well. The production history includes: production (oil, water, gas) and pressure data (bottomhole flowing pressure, static pressure numerical test results), and the results of numerical well test analysis (average permeability, fault information, well-controlled reserves).

At this stage, the trainees may only conduct the following analysis based on the geological information, fluid properties and production history of no more than 10 wells: geological modeling, fluid property analysis, reservoir engineering dynamic analysis (production decline, material balance, flow material balance, water content increase law), so as to form a preliminary understanding of the reservoir.

It should be noted that the geological modeling is performed by the trainees on another computer based on the obtained information, and the geological model is different from the high-precision geological model in the data operation workstation and there are differences. The process of repeatedly revising the geological model established by the trainees according to production dynamic data to make this model close to the high-precision geological model in the data operation workstation is the process of gaining reservoir engineering experience.

S3. Based on the preliminary understanding of the reservoir in the step S2, the trainees issue reservoir development instructions for a next stage on the intelligent terminal. These instructions may include the following:
(1) Drilling instruction: drilling a well at target point coordinates;
(2) Coring instruction: taking a core sample at a depth in a well;
(3) Fracturing instruction: performing fracturing on a well, with fracturing parameters defined by trainees;
(4) Production instruction: performing production of a well within a specified production rate or a bottomhole pressure limit;
(5) Test instruction: testing a static pressure at a bottom of a production well, logging data, and performing a well testing instruction (productivity test and unstable test); and
(6) Injection instruction: injecting water, gas, polymer or surfactant into an injection well.

S4. The data operation workstation receives the development instructions given in the step S3, performs numerical simulation calculations on the reservoir, and feeds calculation results back to the intelligent terminal for the trainees to view. For different development instructions, the corresponding feedback data is obtained:
(1) Drilling feedback: forming a responsive well at target point coordinates.
(2) Coring feedback: feeding back porosity, saturation and permeability parameters, relative permeability curve and capillary pressure curve and fluid properties of a grid at a depth of a well.
(3) Fracturing feedback: feeding back a shape of a pressure construction curve.
(4) Production feedback: feeding back daily production (oil, gas and water) and pressure (bottomhole flowing pressure) over time.
(5) Test feedback: feeding back the static pressure of the test well, a logging curve in the numerical model, and a relationship between the bottomhole flowing pressure and production obtained from the well test.
(6) Injection feedback: a relationship of bottomhole flowing pressure changes in the injection well, and the daily production (oil, gas and water) and pressure (bottomhole flowing pressure) of adjacent wells near the injection well changing with time.

S5. The trainees analyze and determine the reservoir feedback data to update understanding of the reservoir.

At this stage, the trainees may only conduct the following analysis with the production dynamic feedback information of the given reservoir instructions: detailed geological modeling, fluid property analysis, reservoir engineering dynamic analysis (production decline, material balance, flow material balance, water content increase law), thereby forming a new understanding of the reservoir.

The detailed geological modeling is performed by the trainees on another computer based on the obtained information, and this model is different from the high-precision geological model in the data operation workstation and there are differences. The process of repeatedly revising the geological model established by the trainees according to production dynamic data to make this model close to the high-precision geological model in the data operation workstation is the process of gaining reservoir engineering experience.

S6. Based on the updated understanding of the reservoir, the development instructions in the step S3 are readjusted, and the steps S3-S5 are repeated; the understanding of the reservoir is continuously updated through the feedback of the instructions from the reservoir until the oil and gas field development is completed. The process of repeatedly updating and revising the understanding of the reservoir based on the production dynamic data to make it close to the geological model in the data operation workstation is the process of reservoir engineering experience.

S7. After the oil and gas field development is completed, the data operation workstation outputs recovery factor and profit amount of this simulated development.

When the trainees believe that the reservoir may be abandoned, the data operation workstation outputs the final recovery level of this reservoir simulation development based on the cumulative production obtained from each development instruction given by the trainees; and obtains the profit indicator of this development based on the economic cost (drilling cost, coring cost, data acquisition cost, oil price, and the like) of each development instruction given by the trainees.

The present invention further provides a computer-readable storage medium on which computer program instructions are stored, wherein the computer program instructions, when executed by a processor, implements the method for training reservoir engineers based on digital twin technology.

Compared with the prior art, the present invention has the following advantages:
(1) In the training method of the present invention, each reservoir development instruction issued by trainees cannot be revoked, which reproduces the damage and irreparable losses caused by cognitive bias and mistakes to the reservoir development process. The whole process is closer to the actual situation of oil and gas field development, so that the trainees need to handle each step with caution.
(2) The training system and method of the present invention may bring different reservoir development simulation experiences to trainees. Although the instructions cannot be revoked in each development simulation, the process of the present invention is highly repeatable and may obtain correct development experience for a type of reservoir through a plurality of development simulations, which is consistent with the real training process of the reservoir engineers.

Additional advantages, objectives and features of the present invention will be embodied in part through the following description, and in part will be understood by those skilled in the art through study and practice of the present invention.

### BRIEF DESCRIPTION OF DRAWINGS

FIG. 1 is a schematic diagram of training system compositions and data transmission process according to the present invention.

FIG. 2 is a flow chart of a reservoir engineer training process according to the present invention.

FIG. 3 is a diagram of an equipment assembly of a training system in a specific embodiment according to the present invention.

FIG. 4 is a diagram of a matrix net-to-gross ratio model.

FIG. 5 is a diagram of a matrix porosity model.

FIG. 6 is a diagram of a matrix permeability model.

FIG. 7 is a well location distribution map in materials that trainees access to.

FIG. 8 is an oil-water relative permeability curve in materials that trainees access to.

FIG. 9 is a test result diagram of temperature (a) and pressure (b) in materials that trainees access to.

FIG. 10 is a diagram of a porosity model established by trainees on an intelligent terminal based on a petrel platform.

FIG. 11 is a diagram of a permeability model established by trainees on an intelligent terminal based on a petrel platform.

FIG. 12 is a diagram of a water saturation model established by trainees on an intelligent terminal based on a petrel platform.

FIG. 13 is a comparison chart between an output given by a numerical model in a data operation workstation and an output simulated by trainees.

FIG. 14 is an analysis diagram of a flow material balance method.

FIG. 15 is a Blasingame analysis diagram for yield instability analysis.

FIG. 16 is an analysis diagram of a linear flow analysis method.

FIG. 17 is a final development plan diagram submitted by trainees on an intelligent terminal.

### DESCRIPTION OF EMBODIMENTS

The preferred embodiments of the present invention are described below in conjunction with the accompanying drawings. It should be understood that the preferred embodiments described herein are only used to illustrate and explain the present invention, and are not used to limit the present invention.

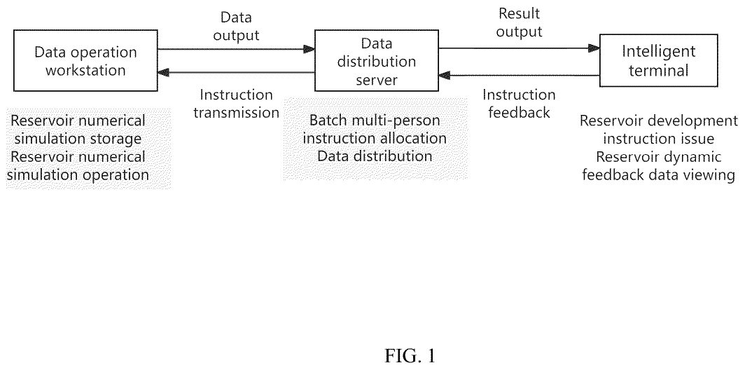

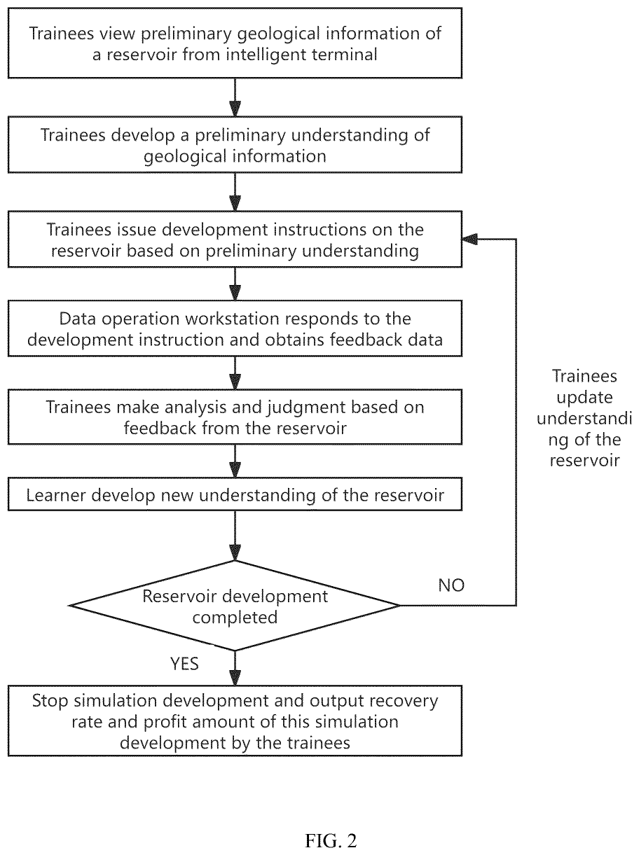

As shown in FIG. 1, a system for training reservoir engineers based on digital twin technology provided in the present invention includes a data operation workstation, a data distribution server, and an intelligent terminal; and the functions of the three parts and the connection relationship therebetween are shown. The training process using the training system is shown in FIG. 2.

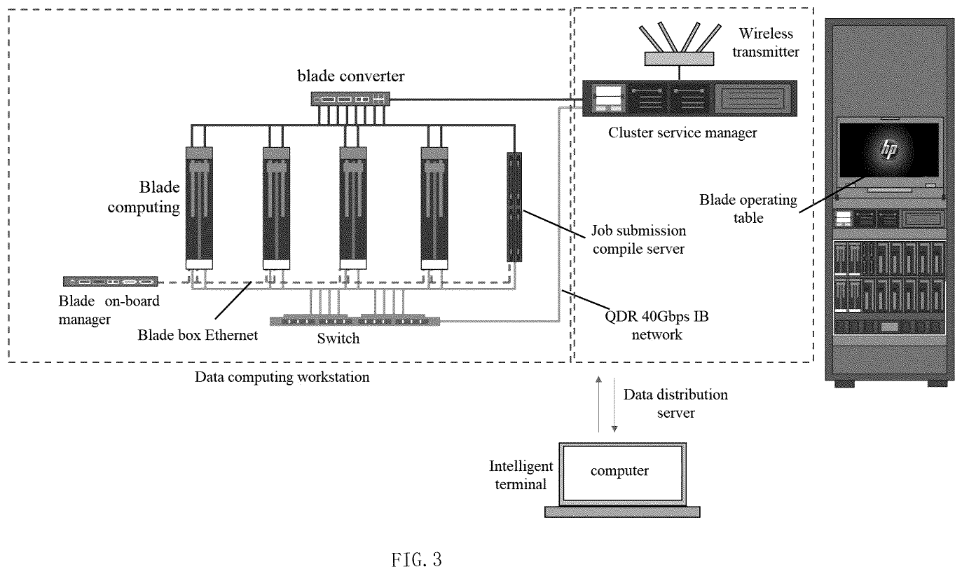

In this embodiment, an HP blade workstation is used as a data operation workstation, a data interaction system provided by the HP blade machine is used as a data distribution server, and a wireless network is used to connect an intelligent terminal, which is a laptop computer. The specific equipment assembly is shown in FIG. 3.

A computing platform in the training system of the present invention may be replaced by any high-performance computing platform under the current Windows system. This embodiment only uses HP workstation as an illustration. The specific steps described below in this embodiment are all based on the Petrel software platform produced by Schlumberger Corporation, which is commonly used in the industry. The software platform combines three modules: techlog logging (which can feedback the logging curve of any well in the model), kinetix fracturing (which can simulate the diffusion of fractures in any well) and Intersect simulation (which can simulate the production-pressure history data under any production conditions). Likewise, this software platform system may also be replaced by other software.

In this embodiment, the training method specifically includes the following steps:

S1. Experts form a numerical model of a type of reservoir based on well-known reservoirs.

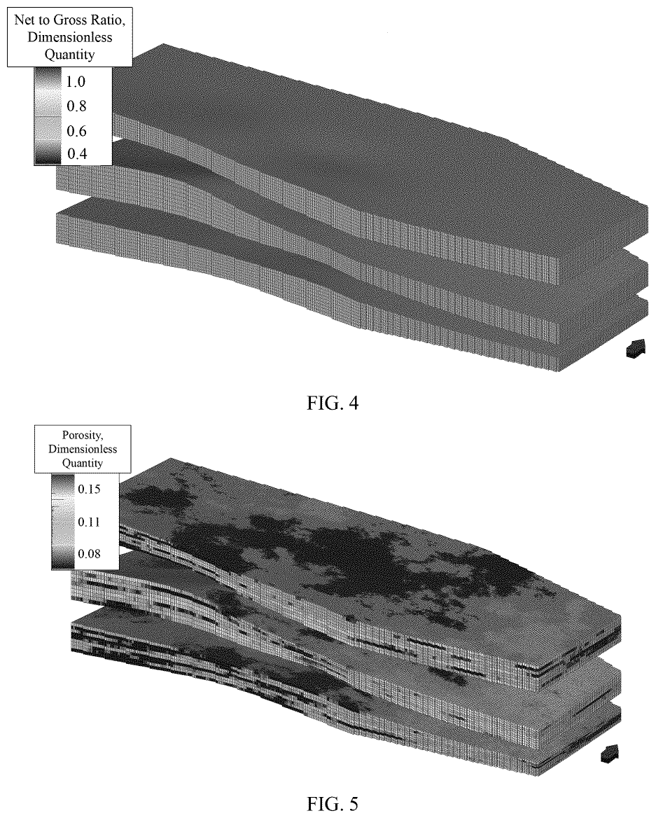

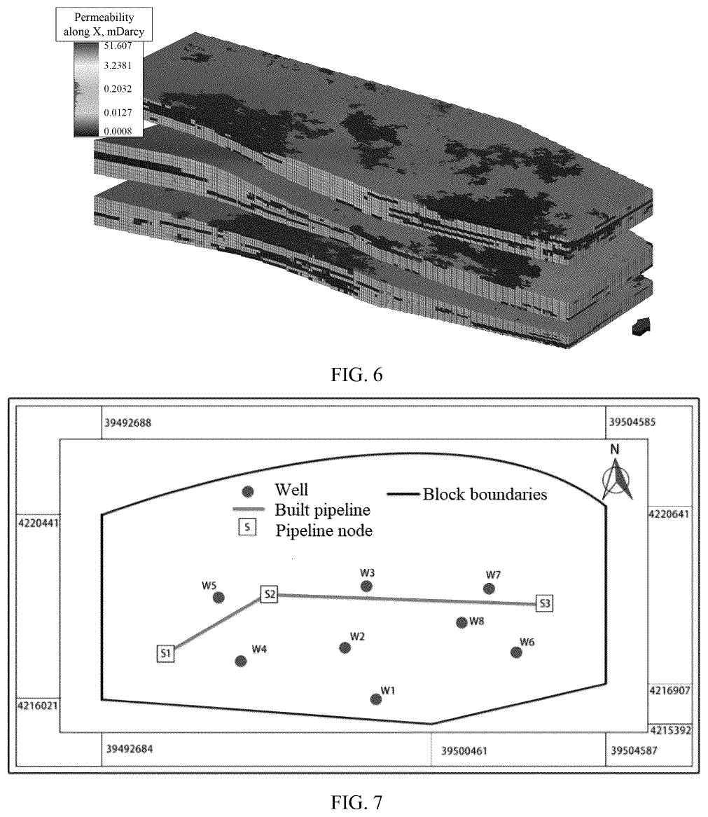

According to the requirements of this embodiment, the experts select a shale oil block in the Luojia region, Shengli Oilfield as a typical shale reservoir development training object. Based on the Petrel platform, the numerical model and geological mechanics model of this reservoir are stored in the data operation workstation. The three-dimensional grid system is (10 m×10 m×1 m). Some properties in the numerical model are shown in FIGS. 4 to 6, which are a matrix net-to-gross ratio model, a matrix porosity model, and a matrix permeability model, respectively.

S2. Trainees view geological information of the reservoir numerical model and form a preliminary understanding.

When the trainees first encounter the reservoir, they can only access the initial geological and dynamic data of the reservoir.

These initial geological and dynamic data are selected by experts and can only represent part of the reservoir information, mainly including seismic results, logging results and test results, which are mainly displayed in the form of graphics and tabular data, specifically as follows:

### (1) Regional Overview

The study block is situated at the structural high of a well within the anticline of the Luojia region, Shengli Oilfield. The primary target reservoirs are the A21, A22, and A23 oil zones, characterized by fine-grained sedimentary rocks, with burial depths ranging from 3700 to 4200 meters. The block has an elevation ranging from 20 to 35 meters above sea level, with an average of 21.5 meters. This block experiences a temperate continental monsoon climate, characterized by an annual average temperature of 11° C., extreme highs of 35° C., lows of −19.5° C., and annual precipitation between 550 and 600 millimeters. The block is bounded by structural belts and contains eight production wells (W1-W8), with their locations shown in FIG. 7.

### (2) Logging Curves and Core Test Results of Existing Wells

The well logging curves and formation division results of existing wells are shown below:

The A Formation, from base to top, consists of three lithological member: “red”, “black”, “red” and “coarse”, “fine”, “coarse”, which are classified as A3, A2, and A1 intervals, respectively, forming a relatively complete, near-symmetric sedimentary cycle. The base is in unconformity contact with the Mesozoic Erathem and the top with Oligocene system. The A2 interval is distinguished from the A1 interval by variations in mudstone color, baseline shifts in well logs, and changes in stratigraphic stacking patterns. With a thickness of 500-600 m, the A2 interval is vertically subdivided into four oil-bearing zones.

The eastern region of the block features a fine-grained facies zone in the A2 interval with a total thickness of approximately 130-210 m, showing stable planar distribution of sub-layers within the fine-grained sedimentary interval. A2-C1 intervals are identified as the priority development sweet spots, while the remaining zones serve as successive production targets. The specific characteristics of the sub-layer are shown in Table 1.

TABLE 1
Characteristics of sub-layers in the A2 interval

| | Oil | Reservoir | |
|---|---|---|---|
| Interval | formation | layer | Characteristic |
| A2 | A2¹ | C₁ | The lithology includes thick-bedded felsic rocks, laminated |
| | | | mixed rocks, and thin-bedded argillaceous limestones, with |
| | | | total organic carbon content of 0.4% to 13%, hydrocarbon |
| | | | generation potential of 40-75 mg/g, and an average brittleness |
| | | | index of 73. |
| | A2² | C₂ | The formation exhibits a thickness of 10-30 m with |
| | | | significant lateral lithological variations. The eastern block is |
| | | | dominated by dark gray mudstones with poor reservoir |
| | | | properties. The western block features fine-grained felsic |
| | | | sedimentary rocks with reservoir potential, where a net pay |
| | | | thickness reaches up to 30 m (typically 20 m). |
| | | C₃ | Interbedded deposition of mixed rocks, felsic rocks, and |
| | | | dolomitic limestones. All three lithotypes exhibit reservoir |
| | | | potential, with various types of pores and microfractures |
| | | | developed across these rock categories. Porosity is |
| | | | predominantly below 12%, while permeability in non-fractured |
| | | | zones is generally <1 mD. Dolomitic limestones show |
| | | | relatively better physical properties with an average porosity of |
| | | | 5.8%, followed by fine-grained hybrid sedimentary rocks |
| | | | (3.3%), and fine-grained felsic sedimentary rocks exhibiting |
| | | | the lowest average porosity (3.1%). The formations |
| | | | demonstrate high brittleness index. The organic carbon content |
| | | | typically ranges from 5% to 6%, with a maximum of 12%, and |
| | | | the hydrocarbon generation potential is 50-80 mg/g. |
| | | C₄ | The lithology is consistent with that of A2-C₃. The organic |
| | | | carbon content typically ranges from 4% to 8%, reaching up to |
| | | | 11%, with hydrocarbon generation potential of 40-80 mg/g. |
| | | C₅ | The lithology consists of thickly interbedded felsic rocks |
| | | | and dolomitic limestones, with thin intercalations of mixed |
| | | | rocks. The porosity ranges from 2% to 5%, while the organic |
| | | | carbon content generally varies between 4% and 6%, reaching |
| | | | up to 12%. The hydrocarbon generation potential is 45-70 |
| | | | mg/g. |
| | A2³ | C₆ | The thicknesses of both the C₆ and C₇ layers range from |
| | | C₇ | 50-60 m, with lithologies primarily consisting of interbedded |
| | | | fine-grained felsic rocks and migmatites. |

The structure is a fault block dipping eastward with higher elevation in the west and lower in the east. The top of the A21 reservoir lies at a structural high point with a burial depth of 3700 meters and a closure amplitude of 500 meters. The key parameters of the fault-block trap are listed in Table 2.

TABLE 2
Parameters of the fault-block trap

| Horizon | Burial depth of high point (m) | Trap amplitude (m) |
|---|---|---|
| A2¹ | −3700 | 500 |

### (3) Deposition Environment

During the depositional period of the A2 interval, four major provenance systems developed around the lake, including the Western Uplift, Northeastern High, Southern High, and Eastern High, along with ten secondary sediment sources. These system form multiple deltaic depositional lobes of varying scales, which overlapped and interconnected. The southern slope area is characterized by a stable, low-angle ramp setting, where deltaic lobes extend far along the basin's long axis. In contrast, the northern basin is fault-controlled with steeper slopes, favoring the development of short-axis lobes.

The inner fine-grained facies belt, distributed in the low-slope area and developed as a prodelta subfacies under deep-lake conditions, consists of fine-grained sedimentary rocks composed mainly of muddy felsic (feldspar and quartz) detritus, carbonates, and clay minerals, with dominant lithologies including silty mudstone, dolomitic mudstone, argillaceous dolomite, and shale, characterized by an average sand-to-strata ratio of less than 5%, rare and poorly sorted sandstone layers, and thick dark mudrocks with TOC exceeding 2%, which indicates excellent hydrocarbon generation potential as the main source rock interval, and exhibits relatively flat gamma-ray and spontaneous-potential curves along with low resistivity, high acoustic transit time, and low density in well-log responses. Gravity flow deposits typically exhibit a “mud-enveloped-sand” characteristic with thick intervals of dark mudstone interbedded with sandstone, displaying distinctive and easily identifiable logging curve, while argillaceous dolomite demonstrates low acoustic transit time, medium-to-high density, low neutron porosity, and anomalously low gamma-ray readings. The seismic reflections are characterized by low-frequency, weak-amplitude parallel events, indicating continuous, stable and well-stratified formations with relatively consistent reflectors, predominantly exhibiting moderate reflection coefficients with relatively small amplitude variations. The three sedimentary facies belts exhibit distinct annular zonation patterns on the average amplitude attribute map, representing variations in seismic reflection energy and seismic facies types corresponding to different lithologic combinations.

The middle and inner rings jointly constitute the fine-grained tight facies zone of the A2 interval, covering an area of approximately 435 km2, which represents about half of the total lacustrine basin area during the lake expansion period. During the depositional period of the A2 interval, under a broadly gentle structural setting, conditions are favorable for the development of extensively distributed tight carbonate and shale reservoirs. However, influenced by variations in depositional environments, lithological differentiation, diverse diagenetic processes, and high-frequency cyclic changes, these widespread tight reservoirs exhibit heterogeneous distribution patterns. Reservoirs with varying carbonate contents, such as argillaceous dolomites, frequently demonstrate concentrated, banded distribution characteristics along with their thickness variations.

### (4) Rock and Mineral Types

The fine-grained sedimentary rocks of the A2 interval are predominantly composed of terrigenous clastics such as quartz and feldspar, averaging 53.0%, with feldspar content particularly high at 41.55%. Carbonate minerals such as dolomite and calcite constitute the second major component at 36.5%, of which dolomite accounts for 23.68%. Clay minerals such as pyrite and analcime represent only 10.5% of the total composition, with clay content averaging merely 6.85%.

The fine-grained facies zone of the A2 interval predominantly consists of felsic shale, calcareous dolomite, and mixed shale. The felsic shale exhibits a thickness of 40 m, accounting for 58.4% of the total formation. Calcareous dolomite represents the second most abundant lithology with a thickness of 15.86 m, accounting for 23.2% of the total formation. Mixed shale completes exhibits a thickness of 12.64 m, accounting for 18.4% of the total formation.

The rock porosity is dominated by secondary intergranular pores, followed by moldic pores, with clay-mineral cementation exhibiting predominantly line-contact bonding. Core sampling statistics of clay mineral content in A2 fine-grained sediments from both the target block and adjacent areas are shown in Table 3.

TABLE 3
Clay mineral content

| Well | | | | | Illite/smectite |
|---|---|---|---|---|---|
| No. | Well interval | Kaolinite | Illite | Chlorite | mixed layer |
| Y1 | 3533.51-3616.56 | 9.8% | 17% | 19.7% | 53.6% |
| Y2 | 3275.113279.46 | 9.7% | 11% | 13% | 66.8% |

### (5) Characteristics of Reservoir Properties

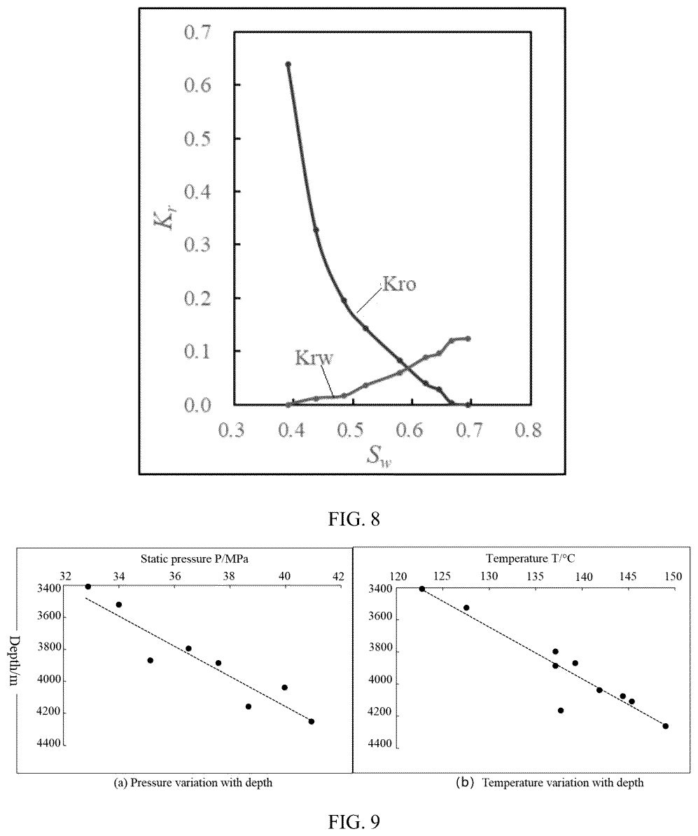

The properties of fine-grained sedimentary rocks in the A2 interval are not significantly affected by lithology. The three major rock are relatively dense as a whole, with porosities mostly distributed below 5%, and permeability in non-fracture development areas is generally <1 mD. Carbonate rocks have a porosity generally distributed between 0.84-2.24%, with an average of 1.41%, and permeability mainly concentrated between 0.02-0.14 mD. The fine-grained hybrid sedimentary rocks have a porosity mainly distributed between 0.941.94%, with an average of 1.64%, and permeability mainly concentrated between 0.01-0.65 mD. The fine-grained felsic sedimentary rocks have a porosity mainly distributed between 0.57-5.1%, with an average of 1.76%, and permeability mainly concentrated between 0.02-0.6 mD. The relative permeability curve of oil and water phases is shown in FIG. 8.

### (6) Characteristics of Reservoir Space and Fractures

All three types of rocks have developed various types of pores and fractures. Dolomite is mainly composed of dolomite intercrystalline pores, structural fractures, differential compaction fractures, and the like. The pores between dolomite crystals may be clearly observed under a scanning electron microscope. Under fluorescent thin sections, it may be found that the dolomite intercrystalline pores and microcracks are filled with blue-green or yellow-white bright oily asphalt. Multiple high-angle differential compaction fractures are often developed on the core, with an opening mainly concentrated in 0.1-3 mm, most of which are filled with asphalt-like substances. The reservoir space of fine-grained felsic sedimentary rocks is mainly composed of organic pores, intergranular pores, bedding fractures and abnormal pressure fractures. A large number of organic pores may be observed under a scanning electron microscope, which are mostly formed after the organic matter is converted into hydrocarbons. A small number of fluorescent intergranular pores may be observed under fluorescent thin sections, and many microcracks may also be observed. The fractures are mostly filled with yellow or bluish-white medium-bright oily asphalt. Dissolved intergranular pores and microcracks may be observed under a laser confocal microscope. Abnormal pressure fractures with a serpentine distribution are often seen on the core, which are mostly filled with pyrite and other substances and are not open or half-open. The reservoir space of fine-grained mixed sedimentary rocks is mainly composed of intergranular pores and interlayer fractures. Under scanning electron microscopy and thin sections, the intergranular pores of analcime can be observed, which are distributed in layers or clumps and are mostly filled with yellow-white oily asphalt. A large number of microscopic bedding fractures may be found under thin sections, accompanied by a large amount of lumpy organic matter, and bedding fractures are often developed on the core. The fine-grained sedimentary rocks in the A2 interval mainly include structural fractures, bedding fractures, differential compaction fractures and abnormally high-pressure fractures.

According to the distribution pattern of in-situ stress (Table 4), the range of dip angle and azimuth angle of the structural fractures in this area may be roughly summarized. First, the overburden pressure is generally smaller than the maximum horizontal principal stress. Therefore, most of the structural fractures are horizontal fractures, and the designed fracture dip angle is in a range of 0°-10°. Secondly, according to the direction of the maximum horizontal principal stress of the in-situ stress, the azimuth range of the structural fractures in this work area is perpendicular to the azimuth angle of the maximum horizontal principal stress, and the designed azimuth angle is between 175°-185°. Based on the description of fracture distribution, a fracture strength model suitable for the work area may be established to lay a good foundation for engineering design.

TABLE 4
In-situ stress and fracture parameters

| | In-situ stress parameters | | | |
|---|---|---|---|---|
| | | Maximum | Minimum | Maximum |
| | Overburden | horizontal | horizontal | horizontal |
| Well | pressure | principal | principal | principal stress |
| depth/m | (MPa) | stress/MPa | stress/MPa | direction/° |
| 3889.57 | 72.05 | 73.7 | 50.15 | 95 |
| 3899.48 | 71.82 | 79.49 | 55.74 | 95 |
| 3911.41 | 72.47 | 73.95 | 48.57 | 95 |
| 3937.29 | 74.09 | 81.11 | 58.66 | 85 |
| 3941.57 | 73.93 | 75 | 51.61 | 85 |

| | | |
|---|---|---|
| Conclusion | Dip angle of | Most of which are horizontal fractures, |
| | fracture | with a dip angle design of 0°-10° |
| | Azimuth | Perpendicular to the direction of maximum |
| | angle of | horizontal principal stress, with an azimuth |
| | fracture | angle design of 175°-185° |

### (7) Reservoir Oil Content

Under the microscope of fluorescent thin sections, fine-grained sedimentary rocks have the characteristics of widespread oil content and local enrichment in the microscopic field. Dolomite has the highest fluorescence brightness, with medium to bright yellow-green and yellow oily asphalt filled in the intercrystalline pores. Hydrocarbons often impregnate dolomite crystals, making the dolomite appear yellow-green or yellow as a whole. Fine-grained felsic sedimentary rocks and fine-grained mixed sedimentary rocks have relatively weak fluorescence intensity, with yellow-brown, brown, yellow-green colloid asphalt, oily asphalt filled in bedding fractures, microcracks, analcime intergranular pores and other reservoir spaces, and even the matrix as a whole showing weak yellow-brown fluorescence. Colloid and oily asphalt are often distributed in fine-grained felsic sedimentary rocks and fine-grained mixed sedimentary rocks in the form of light and dark laminae. Tectonic fractures and bedding fractures are often filled with yellow-green oily asphalt. Analcime laminae often emit yellow-brown medium-dark light, accompanied by organic matter distributed along the layers and emitting yellow-white light.

### (8) Reservoir Type and Fluid Properties

The types of oil reservoirs studied are lithologic oil reservoirs, structural lithologic oil reservoirs and shale oil, which are distributed in overlapping areas.

The relative density of crude oil in a reservoir is between 0.8513 and 0.8919 (20° C.), and the average value is 0.8706 g/cm3; the viscosity of the crude oil is between 8.67 and 22.69 mPa·s (80° C.), the average value is 15.57 mPa·s, the wax content is between 25.98% and 33.24%, and the average value is 28%. The formation water type is CaCl2 type, and the mineralization is 11983 mg/L. The component of the crude oil is shown in Table 5.

TABLE 5
Chemical component and composition of crude oil
Brief table of chemical component and
composition of crude oil in oil fields

| Type | Content (%) |
|---|---|
| Saturated hydrocarbons | 76.48 |
| Aromatic hydrocarbons | 9.45 |
| Non-hydrocarbons | 14.07 |
| Total carbon content | 85.7 |
| Hydrogen content | 13.3 |
| Sulfur content | 0.08 |
| Nitrogen content | 0.92 |

### (9) Reservoir Temperature and Pressure System

The reservoir has a normal temperature and pressure system, with a temperature gradient ranging from 2.86 to 3.12° C./100 m and a pressure coefficient ranging from 0.91 to 1.27. The temperature and pressure changes with depth are shown in FIG. 9. (a) is a graph of pressure variation with depth, and (b) is a graph of temperature variation with depth.

### (10) Oil Test Overview

As shown in Table 6, the A21-A23 oil formations all obtained industrial oil flow in the oil test, and the working system was basically hydraulic pumping after fracturing, with daily oil production ranging from 4.46 to 47.1 m3/d, excluding water. Well W6 was tested in the A21 oil formation in May 2016, with the well intervals of 4050-4137 m. After fracturing, the 3 mm tubing was released, with a daily oil production of 47.1 m3/d, a daily water production of 43.47 m3/d, a cumulative oil production of 1365.97 m3, and a cumulative water production of 630.03 m3. The water in the value is the residual fluid from fracturing.

TABLE 6
Oil test conditions

| | Oil test | | Oil layer | Daily oil |
|---|---|---|---|---|
| Horizon | time | Well No. of oil test | depth m | production t |
| A2¹ | 2012-2015 | W3, W4, W5, W6 and | 3405-4186 | 4.9-47.1 |
| | | W2 | | |
| A2² | 1986-2014 | W4, W1, W2 | 3862-4255 | 4.52-9.28 |

### (11) Pilot Production Overview

Five shale oil pilot production wells were drilled, among which Wells W6, W7, and W8, a total of three wells, achieved relatively good pilot production results.

Well W6 was drilled in 2016, and the A21 oil formation was perforated and fractured, with a well interval of 4050-4137 m. On May 20, the fracturing construction used 2 mm, 3 mm, 4 mm, and 5 mm oil to release and spray for 25 days. The initial oil pressure was 30.8-27.8 MPa, the casing pressure was 22.5-10 MPa, and the daily oil production reached 30-50 m3/d. In the later period, the oil pressure dropped to 1.3-0.42 MPa, the casing pressure dropped to 0 MPa, and the daily oil production dropped to 15-25 m3/d. The cumulative oil production was 646.85 m3, and the cumulative residual liquid released was 584.93 m3.

Well W7 was drilled in 2017, and the A21 oil formation was perforated and fractured, with a well interval of 4345-5278 m. A total of 16 fracturing sections were performed, with a total fracturing fluid volume of 34089.28 m3 and a total sand volume of 1387.83 m3. Until now, the well flowing through a 5 mm choke maintains a wellhead pressure of 2.4 MPa, the daily liquid production is 98.0 m3/d, the daily oil production is 17.8 m3/d, the daily gas production is 921 m3/d, the cumulative liquid production is 9079.7 m3, the cumulative oil production is 579.1 m3, and the cumulative gas production is 27373 m3.

Well W8 was drilled in 2017, and the A21 oil formation was perforated and fractured, with a well interval of 3952.4-5229.5 m. A total of 21 fracturing sections were performed, with a total fracturing fluid volume of 40678.07 m3 and a total sand volume of 1343.26 m3. Until now, the daily liquid production is 104.0 m3/d, the daily oil production is 23.8 m3/d, the daily gas production is 1291 m3/d, the cumulative liquid production is 11028.6 m3, and the cumulative oil production is 746.1 m3.

### (12) Characteristics of Oil Test and Pilot Production

1. Most oil wells have low natural production capacity before fracturing, with daily liquid production ranging from 0.04 to 2.87 m3/d, which cannot reach industrial oil flow.
2. The effect after fracturing is obvious, but the fracturing effect varies greatly. The W5 and W6 wells produce 15.45-47.1 m3 of oil per day through spontaneous flow production. The other wells produce oil by hydraulic pumping after fracturing, with a pump pressure of 15-25 MPa and a daily oil production of 4.46-26.77 m3/d.
3. The natural energy of the reservoir is relatively weak, and the spontaneous flow period of the new well after fracturing is short. After the W5 well was fractured, the 2 mm choke sprayed for 28 days.
4. The production rate was high in the initial stage of trial production, but decreased significantly. The daily oil production of Well W5 dropped from 15.45 m3/d to 6.8 m3/d after 20 days of spontaneous flow.

S3. Trainees issue instructions on the reservoir development process:

Based on the preliminary understanding of the reservoir in the step S2, the trainees build their own geological model and numerical model describing the reservoir based on the petrel software platform on an intelligent terminal (such as a laptop computer), and issue development instructions for the next stage of the reservoir based on the established model.

The trainee analyzes the data obtained in the step S2 (the trainee cannot see the actual numerical model in the data computing server, but can make inferences based on the data obtained in the step S2). In this training, the trainees select to establish the geological model and the numerical model describing the reservoir by intelligent terminals to simulate the development of the target reservoir.

The trainees first organize the interpreted porosity and permeability of the wells into a format recognizable by Petrel and imported this format into the model. Then the curves are discretized, and geological modeling and numerical modeling are studied. The details are as follows:
(1) Establishment of porosity model

First, data discretization is performed. The accuracy of attribute modeling is closely related to the data source. The data on the well is discretized into a three-dimensional grid through a certain algorithm. In this way, the size of the grid also has a certain impact on the data results. In addition, the selection of discretization algorithm also has an impact on the simulation results. It is known from the discretization results that the statistical distribution trend and main peak value of the data before and after discretization in each figure are almost consistent, which shows the reliability of the discretization of logging data and lays a solid foundation for subsequent attribute simulation.

The data discretization only assigns various attribute valuesto the three-dimensional grid (30 m×30 m×5 m) corresponding to the well trajectory. The next step is to simulate the attribute values of the grids between wells through various methods and control conditions to establish a complete attribute model. The grid attributes here are different from those in the server and are established by the trainees.

In the process of random modeling, the variogram is the basis of random simulation. The trainees conduct porosity variogram fitting analysis based on the petrel platform on the intelligent terminal. The variogram analysis is performed on various attributes under the control of lithofacies, the spherical model is selected as the basic theoretical model, and the variation values of the main direction, secondary direction and vertical direction are determined through data analysis, which provides a basis for the achievement of the final result of random simulation.

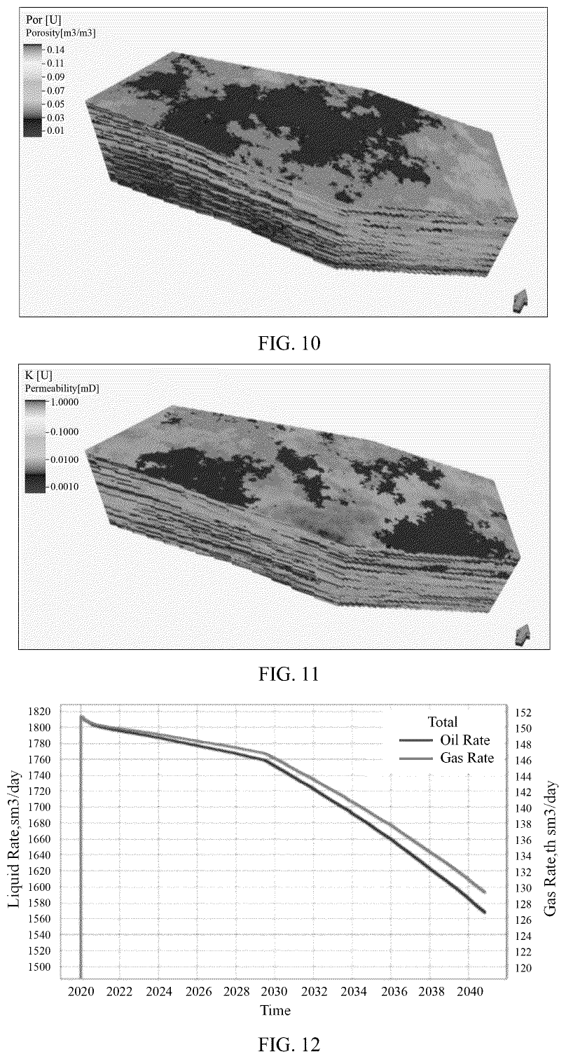

The work area is large. With the help of geological static model, comprehensive analysis of previous geological research and sedimentary phase constraints, the porosity of mudstone blocks is 0, the geological statistical characteristics of reservoir parameters are grasped, and the main range of shale phase is designed to be 2500 m and the secondary range is 1600 m in the sequential Gaussian modeling method; and the main range of mixed rock is designed to be 1500 m and the secondary range is 1100 m, so that the porosity extension range is further determined. The porosity model is established as shown in FIG. 10.
(2) Establishment of permeability model

The data is also subjected to discretization and variogram analysis. The discretization results show that the statistical distribution trend and main peak value of the data before and after discretization in each figure are almost consistent. Combined with the porosity profile, it is known that the distribution of permeability is well consistent with the distribution of porosity.

Therefore, with the help of sedimentary facies constraints and the use of sequential Gaussian modeling method, the permeability of the mudstone block is designed to be 0, the main range of the shale phase is 2600 m, and the secondary range is 1500 m; the main range of dolomite and mixed rock is designed to be 1500 m, and the secondary range is 1000 m, so that the extension range of permeability is further determined. The permeability model is established as shown in FIG. 11.
(3) Establishment of water saturation model

The water saturation simulation method often uses the Kriging continuous modeling method, which may better reflect the continuity of water phase flow. Therefore, on the basis of the porosity and permeability model, phase control constraints are also performed, and the main range, secondary range and porosity are consistent. The obtained water saturation model is shown in FIG. 12.

The trainees arrange a number of pilot wells based on the characteristics of the work area. The shale oil reservoir in the work area is a tight shale oil reservoir with low porosity, low permeability and low abundance, containing trace amounts of condensate gas and a low dew point pressure. According to the current oil test and pilot production data and existing research, as the formation pressure decreases during the development process of the target layer, the content of retrograde condensate is very low and does not cause damage to the reservoir. Therefore, in the early stage of horizontal wells, depletion-type fixed-production oil production may be used. Through numerical simulation calculations, it is predicted that the allocated production of shale gas reservoirs is 20-30 m3/d.

S4. The data operation workstation receives instructions, performs simulation operations and feeds back data.

The data operation workstation receives the instructions given in the step S3, performs numerical simulation calculations on the reservoir, and feeds the calculation results back to the intelligent terminal for the trainees to view.

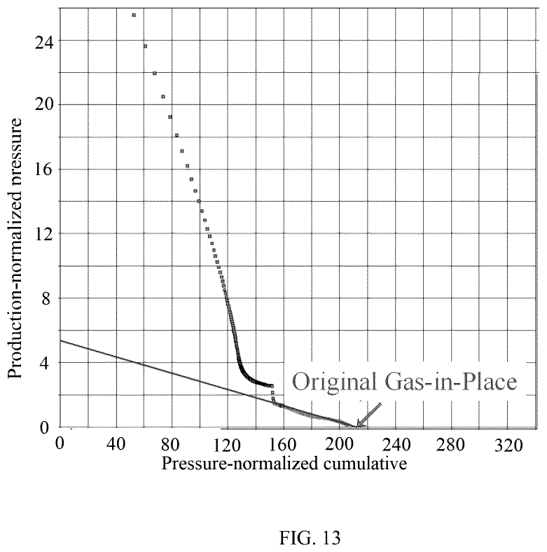

The trainees predict the production capacity based on the RE numerical simulation module of the petrel platform on the intelligent terminal. Since the numerical model established by the trainees is not accurate and has a large difference from the actual model when there was less data, there is a certain difference between the production decline process given by the numerical model in the data storage workstation and the predicted production capacity result, as shown in FIG. 13.

S5. The trainees analyze feedback data and update an understanding of the reservoir.

At this stage, the trainees may only conduct the following analysis with the production dynamic feedback information (FIG. 13) of the given reservoir instructions: detailed geological modeling, fluid property analysis, reservoir engineering dynamic analysis (production decline, flow material balance), thereby forming a new understanding of the reservoir.

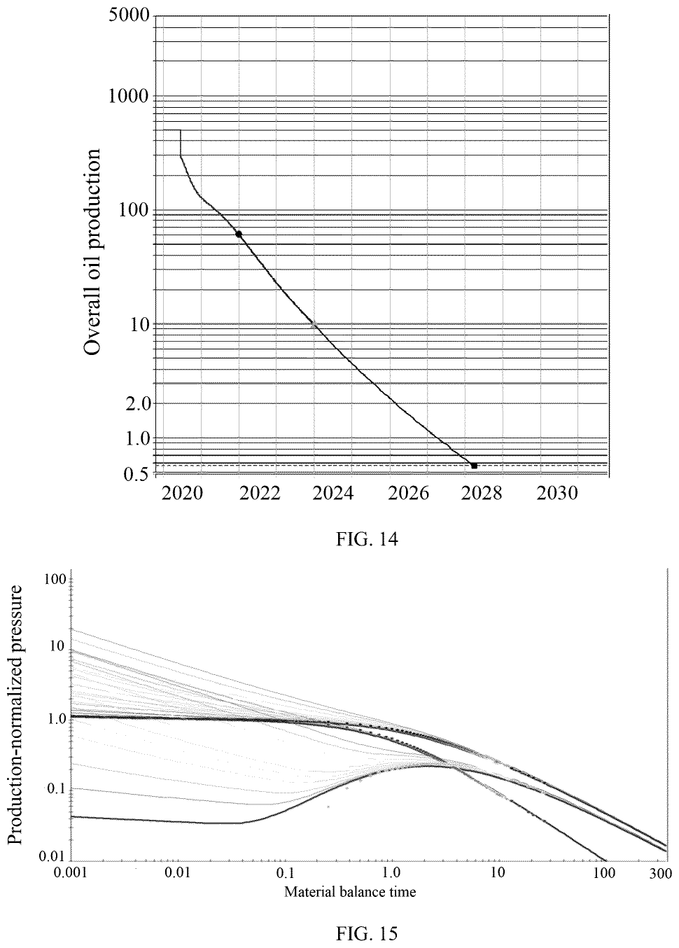

Based on the production feedback, the trainees conduct a dynamic analysis of the production wells. An example of the analysis process is shown in FIGS. 14-16. The trainees conduct reservoir engineering analysis based on the production history provided by the data storage server and further understand the characteristics of the reservoir through inversion parameters. FIG. 14 shows a flow material balance method, which mainly analyzes the reserve information of the stratum where the well is located. The reserves interpreted here are 2.13 million tons, which is quite different from the 6.88 million tons in the geological modeling by the trainees, indicating that the trainees overestimates the quality of the reservoir in the geological modeling process.

For an oil well, the flow material balance method may be represented as:

$$\frac{( {p}_{i} - {p}_{wf} )}{q} = m t + {b}_{pss} \qquad ( 1 )$$

$${b}_{pss} = \frac{μ B}{4 π Kh} ln ( \frac{4 A}{{C}_{A} {e}^{γ} {r}_{w}^{2}} ) , {( MPa \cdot d / {m}^{3} )}^{- 1}$$

wherein A is the area, m²; B is the volume coefficient, m³/m³; C_{A} is the shape factor; h is the formation thickness, m; K is the formation permeability, mD;

$$m = \frac{1}{{NC}_{t}} , MPa / {m}^{3} ;$$

pᵢ is the original pressure, MPa; p_{wf} is the bottomhole flowing pressure, MPa; q is the daily production, m³/d; rₑ is the well control radius, m; t is the time, h; and μ is the viscosity, mPa·s

The

$$\frac{( {p}_{i} - {p}_{wf} )}{q} , t$$

relationship curve is drawn using formula (1), and the size of the reserve value N may be calculated based on the slope.

FIG. 15 shows the Blasingame analysis method in production instability analysis, which mainly analyzes the permeability near the well and obtains an average permeability of 0.045 mD, which is an order of magnitude different from the average of 0.0013 mD in the geological model, indicating that the permeability near the well is underestimated.

The material balance time is the ratio t_{c}=Nₚ/q of the current cumulative output to the daily output. This formula may be used to establish an equivalent relationship between variable output production and fixed output production. If the pressure wave propagates to the closed boundary, the reservoir flow enters the boundary-controlled flow propagation period. In this stage, the well production comes entirely from the elastic expansion of fluid and rock caused by the drop in formation pressure.

For a circular bounded homogeneous formation, for any closed formation, the pseudo-steady bottomhole pressure may be represented as:

$$\overline{p} - {p}_{w f} = \frac{q μ B}{2 π K h} ( ln {r}_{eD} - \frac{3}{4} ) = \frac{q μ B}{4 π K h} ln \frac{4 A}{{C}_{A} {e}^{γ} {r}_{w}^{2}} \qquad ( 2 )$$

wherein A is the drainage area, C_{A} is the Dietz (1965) shape factor, γ is the Euler constant, and for a circular closed formation,

$${C}_{A} = 4 π {e}^{\frac{3}{2} γ} \approx 31.62 .$$

r_{eD} is the dimensionless well control radius,

$${r}_{e D} = \frac{{r}_{e}}{{r}_{w}} ;$$

and p̅ is the average pressure, MPa.

The formula (2) may be rearranged to obtain

$$\frac{( {p}_{i} - {p}_{wf} )}{q} = \frac{μ B}{Kh} {t}_{cD} + \frac{μ B}{4 π K h} ln ( \frac{4 A}{{C}_{A} {e}^{γ} {r}_{w}^{2}} ) \qquad ( 3 )$$

wherein t_{cD} is the dimensionless material balance time of the oil well,

$${t}_{cD} = \frac{K}{ϕμ {C}_{t} A} {t}_{c} ;$$

and t_{c} is the material balance time of the oil well, t_{c}=Nₚ/q,d.

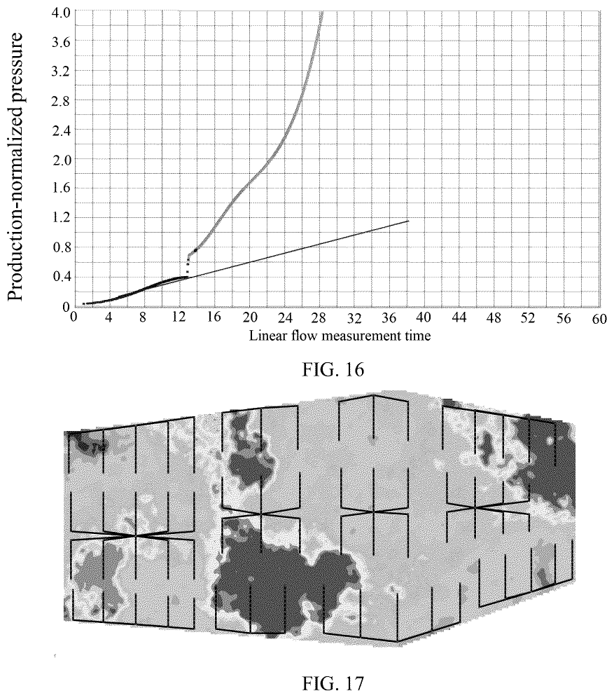

FIG. 16 shows a linear flow analysis method, which mainly analyzes the distance of the well to the control boundary. According to the analysis results, the well may only control the reserves near 224 m, indicating that the connectivity of the reservoir is poor.

The linear flow analysis method is as follows: assume that in the middle of a rectangular formation with boundaries 2xₑ and 2yₑ and a closed outer boundary, a well produces at a constant rate of q, the fracture passes through the boundary, x_{f}=xₑ, the distance from the well to the boundary is y_{w}, yₑ=y_{w}, the bottomhole pressure is p_{wf}, the formation thickness is h, the original formation pressure is pᵢ, the wellbore radius is r_{w}, the formation porosity is ϕ, the comprehensive compression coefficient is Cₜ, the formation permeability is K, the fluid density is μ, the volume coefficient is B, and the influence of the skin effect is not considered.

The linear flow analysis formula is as follows:

$$p ( y , t ) = {p}_{i} - \frac{q μ B}{2 {x}_{f} Kh} \{ [ \frac{{( {y}_{e} - y )}^{2}}{2 {y}_{e}} - \frac{{y}_{e}}{6} + \frac{η t}{{y}_{e}} ] - \frac{2 {y}_{e}}{{π}^{2}} {\sum }_{n = 1}^{∞} ( \frac{1}{{n}^{2}} ) {e}^{- {η ( \frac{n π}{{y}_{e}} )}^{2} t} cos ( \frac{n π y}{{y}_{e}} ) \} \qquad ( 4 )$$

wherein η is the pressure conductivity coefficient, η=K/(μϕCₜ)

The dynamic analysis process in FIGS. 14-16 is based on the SWPU-RTA software developed by Southwest Petroleum University, and may also be completed using other dynamic analysis software (such as HIS-Harmony).

It may be seen from the results of the dynamic analysis that, based on the dynamic analysis, the trainees further determine the reserves controlled by the well, the permeability near the well, and the like, and then the trainees revise their numerical models on the intelligent terminal. The average permeability of the revised numerical model is 0.45×10−3 μm2, the average porosity ϕ is 0.08, the effective thickness is 30 m, and the initial oil saturation is 0.58.

During this process, the trainees repeatedly revise the geological model established based on production dynamic data to make this model close to the high-precision geological model in the data operation workstation, and determine the possible historical fitting and adjustment direction of shale oil reservoirs. This process is the process of gaining reservoir engineering experience.

S6. Steps S3-S5 are repeated until the development is completed.

The trainees repeat the steps S3-S5 based on their updated understanding of the reservoir, continuously update their understanding of the reservoir through feedback from the reservoir on the instructions, and repeatedly revise their understanding of the reservoir based on production dynamic data. Finally, the trainees submit a development plan for the reservoir, as shown in FIG. 17.

Combined with factors such as the size of the mechanism research area and the characteristics of the reservoir fractures, the horizontal well network is designed according to the above horizontal well network design principles and reservoir adaptability at a certain injection-production well ratio between vertical wells and horizontal wells. Only depletion development is performed using the conventional double-row mode of the horizontal well “well factory” combined with vertical well gas injection.

S7. The data operation workstation outputs the recovery factor and profit amount indicators of this simulated development.

When the trainees believe that the shale oil reservoir may be abandoned after the wellhead production is less than 2 cubic meters per day, the data operation workstation outputs the final recovery rate of this reservoir simulation development as 6.85% based on the cumulative production obtained according to each development instruction of the trainees; and obtains the profit indicator of this development based on the economic cost (drilling cost, coring cost, data acquisition cost, oil price, and the like) of each development instruction of the trainees.

The profit index calculation method is:

According to the requirements of the Economic Evaluation Methods and Parameters promulgated by the State Planning Commission, and based on the current national fiscal and taxation systems as well as the price framework, this study estimates the investment costs and profitability of the proposed plan by incorporating the actual conditions of oil and gas field development. The evaluation is conducted on technically feasible development plans in reservoir engineering design, and the project's profitability, solvency, and other financial conditions are assessed to determine financial feasibility.
(1) Investment in drilling and completion engineering

The cost of drilling and completion engineering includes drilling engineering costs and completion engineering costs. The costs during the construction process include direct material costs, direct labor costs, machinery usage fees, other direct costs, manufacturing costs, and the like. It is estimated that the investment for each horizontal well is about 50 million yuan, and the investment for each vertical well is about 10 million yuan.
(2) Investment in oil production engineering

The construction investment of oil production projects includes fracturing investment, lifting investment, gas injection costs, wax prevention costs, and the like.

The various investments in oil production technology are analyzed and determined. The results are shown in Table 7:

TABLE 7
Investment in oil production engineering

| Project | | Amount | |
|---|---|---|---|
| Fracturing | Equipment mobilization | 1000 | |
| investment | On-site fluid preparation | 1500 | |
| | Material costs | 200 | |
| | Transportation | 500,000 | yuan/well |
| | Labor | 600,000 | yuan/well |
| Lifting | Wellhead equipment | 800,000 | yuan/well |
| investment | Wax prevention | 1 | million/well/year |
| | Downhole equipment | 1 | million/well |
| Gas injection | CO₂ injection | 500 | yuan/ton |
| costs | N₂ injection | 1200 | yuan/ton |
| | Hydrocarbon gas injection | 0.5 | yuan/m3 |
| | CO₂ and CH₄ compressor | 300,000 | yuan/compressor |
| | N₂ compressor | 200,000 | yuan/compressor |
| Fluid | Oil/gas production | 440 | yuan/m3 |
| processing | Wastewater treatment | 50 | yuan/m3 |

(3) Investment in ground gathering and transportation projects

Investment in surface engineering of oil and gas fields includes: well site, oil gathering valve group, joint station, duty point, off-site oil gathering and transportation pipeline, off-site power supply and distribution lines and communications, roads, and the like. Auxiliary projects include lines, power supply projects, water supply and drainage, communications, roads, environmental protection, energy conservation and other engineering investments, as shown in Table 8.

TABLE 8
Investment in ground gathering and transportation projects

| | | Amount | Total |
|---|---|---|---|
| | | (million | (million |
| Project | | yuan) | yuan) |
| Equipment and | Well site | 10 | 70 |
| construction | Pipeline and laying | 10 | |
| costs | Valve group | 10 | |
| | Joint station | 50 | |
| Auxiliary | Water supply and drainage | 5 | 28 |
| projects | engineering | | |
| | Heating and HVAC (heating, | 2 | |
| | ventilation, and air conditioning) | | |
| | Equipment and pipeline anti- | 3 | |
| | corrosion | | |
| | Fire expenses | 2 | |
| | Automatic control and | 2 | |
| | communication system | | |
| | Product testing fee | 1 | |
| | Equipment repair and maintenance | 2 | |
| | fees | | |
| | Equipment insurance premium | 1 | |
| | Wastewater treatment | 10 | |

| | |
|---|---|
| Environmental protection and construction | 1 |
| supervision | |
| Engineering construction services | 5 |
| Total | 140 |

(4) Taxes

Business taxes mainly include value-added tax, urban maintenance and construction tax, resource tax and corporate income tax. The specific collection ratios are shown in Table 9.

TABLE 9
Tax types and tax rates

| Project | Tax rate |
|---|---|
| Value-added tax | 17% |
| Additional tax for urban construction | 5% of value-added tax |
| Additional tax for education | 3% of value-added tax |
| Mineral resource compensation tax | 5% |
| Corporate income tax | 25% |

(5) Other costs

Other costs include administrative costs, financial costs, sales costs, and the like. The administrative costs refer to the costs incurred by the administrative department of an enterprise for managing and organizing business activities. Based on oil field development experience, this part of the cost is calculated at 8.8 million yuan per year. The financial costs refer to the various costs incurred by an enterprise in raising funds, including interest expenses, consolidated profit and loss, foreign exchange adjustment fees, financial institution fees and other financial expenses incurred during the production and operation of the enterprise. That is to say, the interest on fixed asset loans and working capital loans is included in financial costs. The sales costs refer to the various costs incurred by an enterprise in the process of selling products, making semi-finished products and providing services, as well as the various expenses of dedicated sales organizations. Based on the average sales cost of the industry in recent years, it is calculated at 1.8 million yuan per year.

Financial net present value (NPV) is used for economic evaluation. The financial net present value is a dynamic assessment indicator that reflects the profitability of the project over the computing period. The financial net present value of a project refers to the sum of the present values of the net cash flows of each year discounted to the starting point of construction based on the benchmark rate of return or a set discount rate.

Based on the current crude oil price of US$50 per barrel, the total profit of this shale oil development simulation over 17 years is −823 million yuan.

The trainees conduct a development simulation again, using energy storage fracturing 30 CO2 throughput to simulate development. After 22 years, the oil reservoir is abandoned, and the final recovery rate is 14.32%. Under the condition of US$50 per barrel, the total profit was −1.454 billion yuan.

After multiple simulation developments, the trainees summarize the focus of the explicit shale reservoir development to focus on the evaluation of oil-bearing sweet spots, the analysis of interwell connectivity and the analysis of reservoir sedimentary facies. In addition, the trainees explicitly defines that below oil price of US$90/barrel, the enhanced oil recovery measure is effective for shale reservoirs, but there is a considerable economic cost, and the enhanced oil recovery measure has economic value only under the condition of high oil price (more than US$90/barrel).

The above descriptions are only preferred embodiments of the present invention, and are not intended to limit the present invention in any form. Although the preferred embodiments above have disclosed the present invention, they are not intended to limit the present invention. Any of those familiar with the technical field, without departing from the scope of the technical solutions of the present invention, can use the technical content disclosed above to make various changes and modify the technical content as equivalent changes of the equivalent embodiments. However, any simple modifications, equivalent changes and modifications made to the above embodiments according to the technical spirit of the present invention without departing from the content of the technical solutions of the present invention shall fall within the scope of the technical solutions of the present invention.

What is claimed is:

1. A system for displaying a reservoir numerical model based on digital twin technology, comprising: a data operation workstation, a data distribution server, and an intelligent terminal; wherein:
the data operation workstation is configured to receive a reservoir development instruction transmitted from the data distribution server, perform simulation calculation on data input through an intelligent terminal according to the reservoir development instruction, and output a calculation result to the intelligent terminal through the data distribution server, wherein the data operation workstation comprises:
a reservoir numerical model storage module configured to store data information of a currently developed reservoir and establish and store a three-dimensional reservoir numerical model by performing grid encryption after a geological model and an in-situ stress model are fused based on the data information; and
a reservoir numerical simulation operation module configured to perform the simulation calculation according to the reservoir development instruction and generate dynamic feedback data of the simulation calculation to be sent to the intelligent terminal through the data distribution server;
the data distribution server is configured to receive the reservoir development instruction from the intelligent terminal, transmit the reservoir development instruction to the data operation workstation; and distribute the dynamic feedback data from the data operation workstation to the intelligent terminal, and
the intelligent terminal is configured to:
access and display the data information of the currently developed reservoir and the reservoir numerical model stored in the data operation workstation,
issue the reservoir development instruction based on a user's interactive operation on the intelligent terminal, and
display the dynamic feedback data of the simulation calculation in the data operation workstation.

2. The system according to claim 1, wherein the reservoir numerical model storage module stores data information of a reservoir that has been developed for more than ten years and selected by an industry expert that has a full understanding of the reservoir based on the type of a same type to-be-developed reservoir.

3. The system according to claim 2, wherein the geological model comprises data on stratigraphic horizons, depth, porosity, permeability, saturation, water zones, sensitivity, relative permeability, and capillary pressure distribution, and the in-situ stress model comprises data on fracture zones, Young's modulus, Poisson's ratio, and Lame constants distribution.

4. The system according to claim 1, wherein the intelligent terminal is further configured to:
display top surface horizon data of the reservoir, the top surface horizon data comprises geological information, fluid properties, and production history for no more than 10 wells within a one-year period, and
perform geological modeling, fluid property analysis, and reservoir engineering dynamic analysis to develop a preliminary understanding of the reservoir.

5. The system according to claim 4, wherein:
the geological information comprises a numerical logging curve given by the reservoir numerical model, a porosity-permeability-saturation test result at a production well, and a relative permeability curve and a capillary pressure curve measured at a production well;
the fluid properties comprise phase behavior, density, viscosity, and volume factor of a fluid at a production well; and
the production history comprises production rates, pressure data, and numerical well test analysis results.

6. The system according to claim 5, wherein the reservoir development instruction comprises:
drilling instruction: drilling a well at target point coordinates;
coring instruction: taking a core sample at a depth in a well;
fracturing instruction: performing fracturing on a well, with fracturing parameters defined by trainees;
production instruction: performing production of a well within a specified production rate or a bottomhole pressure limit;
test instruction: testing a static pressure at a bottom of a production well, logging data, and performing a well testing instruction; and
injection instruction: injecting water, gas, polymer or surfactant into an injection well.

7. The system according to claim 6, wherein the dynamic feedback data comprises:
feedback on the drilling instruction: forming a responsive well at target point coordinates;
feedback on the coring instruction: feeding back porosity, saturation and permeability parameters, a relative permeability curve and a capillary pressure curve, as well as fluid properties of a grid at a depth of a well;
feedback on the fracturing instruction: feeding back a shape of a pressure construction curve;
feedback on the production instruction: feeding back daily production and bottomhole flowing pressure over time;
feedback on the test instruction: feeding back the static pressure of a test well, a logging curve in the numerical model, and a relationship between the bottomhole flowing pressure and production obtained from the well test; and
feedback on the injection instruction: a relationship of bottomhole flowing pressure changes in the injection well, and daily production and bottomhole flowing pressure of adjacent wells near the injection well changing with time.

8. A method by adopting the system according to claim 1, comprising the following steps:
S1: forming a reservoir numerical model of a reservoir based on data information of a same type reservoir that has been developed for more than ten years and selected by an industry expert that has a full understanding of the reservoir based on the type of a to-be-developed reservoir, and storing the reservoir numerical model in the data operation workstation;
S2: displaying geological information of the reservoir numerical model by the intelligent terminal to form a preliminary understanding of the reservoir;
S3: based on the preliminary understanding of the reservoir issuing, by the intelligent terminal, a reservoir development instruction for a next stage;
S4: receiving, by the data operation workstation, the reservoir development instructions performing numerical simulation calculation on the reservoir, generating feedback data of the numerical simulation calculation, sending the feedback data to the intelligent terminal, and displaying, by the intelligent terminal the feedback data;
S5: analyzing and determining the feedback data to update the understanding of the reservoir;
S6: base on the updated understanding of the reservoir, readjusting the development instruction in the step S3, and repeating the steps S3-S5; continuously updating the understanding of the reservoir by issuing feedback data of the reservoir development instruction from the reservoir until oil and gas field development is completed; the process of repeatedly updating and revising the understanding of the reservoir based on production dynamic feedback data to make the understanding close to the geological model in the data operation workstation is the process of reservoir engineering experience; and
S7: after the oil and gas field development is completed, outputting, by the data operation workstation, recovery factor and profit amount of this simulated development.

9. The method according to claim 8, wherein in the step S5, detailed geological modeling, fluid property analysis and reservoir engineering dynamic analysis are performed through the production dynamic feedback data of a given development instruction, thereby forming a new understanding of the reservoir; the detailed geological modeling is a geological model newly established based on the information obtained, this newly established model is different from the geological model in the data operation workstation, the newly established geological model is repeatedly revised according to production dynamic feedback data to make this newly established model close to the geological model in the data operation workstation.

10. A computer-readable storage medium on which computer program instructions are stored, wherein the computer program instructions, when executed by a processor, implements the method according to claim 8.
